(19) United States
(12) Patent Application Publication
(10) Pub. No.: US 2013/0038429 A1
(43) Pub. Date: Feb. 14, 2013

(54) Wireless Communication System

(71) Applicants: Yasutaka Koike, Mobara-shi (JP); Masahiro Tanaka, Mobara-shi (JP)

(72) Inventors: Yasutaka Koike, Mobara-shi (JP); Masahiro Tanaka, Mobara-shi (JP)

(21) Appl. No.: 13/564,801

(22) Filed: Aug. 2, 2012

(30) Foreign Application Priority Data
Aug. 10, 2011 (JP) 2011-175100

(51) Int. Cl. G08C 19/16

(52) U.S. Cl. 340/12.5

(57) ABSTRACT

A servo device 30 includes: a control portion 31 for driving and controlling a drive mechanism 32 by receiving a control signal from a transmitter 10, and by transforming the control signal into a drive signal corresponding to characteristic data previously stored in a memory portion 35. The control portion 31 includes: a signal processing portion 33 for discriminating whether the control signal is a maneuver signal or a characteristic data signal; and the memory portion for updating and storing the characteristic data based on the received characteristic data signal when the control signal is discriminated as the characteristic data signal.

### CROSS REFERENCE TO RELATED APPLICATIONS

This application is on the basis of Japanese Patent Application No. 2011-175100, the contents of which are hereby incorporated by reference.

### BACKGROUND OF THE INVENTION

1. Technical Field

The present invention relates to a wireless communication system used for a remote control of hobby equipment such as a model airplane or a model car, and industrial equipment such as a crane truck, in particular, a wireless communication system configured to reduce power consumption of a controlled object side communication device mounted on a controlled object to be remotely controlled.

2. Background Art

A radio control system for remotely controlling a controlled object in a distant place using a radio wave is used for a hobby use for competing on a maneuver technique such as speed or acrobatics by maneuvering a model airplane, a model car, or a model helicopter and for an industrial use for maneuvering a crane truck or the like.

In the radio control system used for the hobby use, a controlled object side communication device and a drive control portion such as a servo device for driving and controlling a throttle lever of an engine or the like are mounted on a controlled object. When the controlled object is a model airplane, the servo device drives and controls a flap, an aileron, and the like.

In the controlled object side communication device, a battery is used as a power source. Various types of batteries are used such as NiCad battery, nickel-hydrogen battery, and lithium polymer battery. When a power source voltage of the controlled object side communication device is reduced, normal communication cannot carried out, maneuvering of the controlled object is impossible, and the controlled object becomes a very dangerous condition. Therefore, there is a battery failsafe function that works when the power source voltage becomes under a certain value. This battery failsafe function notifies an operator of a reduction of the power source voltage of the controlled object side communication device mounted on the controlled object through an action of the controlled object.

In general, the battery failsafe function fixes an acting position of the servo device to a predetermined position when the power source voltage of the controlled object side communication device becomes under a specific value. In case that the controlled object is a model air plane, by fixing the acting position of the servo device, the controlled object circles over or the like. Further, when the battery failsafe function affects the servo device which controls the throttle lever of the engine, the number of revolutions of the engine can be controlled to the minimum. The controlled object notifies the operator of the reduction of the power source voltage by such an action, and urges the operator to stop the maneuvering of the controlled object and collect the controlled object rapidly.

When a specific action is done by a maneuvering gear after the battery failsafe function works, the battery failsafe function can be temporarily cancelled, and in a certain period of time, the controlled object can be maneuvered. After the certain period of time, the battery failsafe function works again. After that, this action is repeated until the operation is disabled by the further battery consumption. When the operator confirms the battery failsafe function works from the action of the controlled object, the operator can stop the controlled object in a safe place and collect the controlled object before the operation is disabled.

As shown in FIG. 5, PTL 1 discloses a controlled object side communication device 30. A not-shown maneuvering gear generates and sends a battery failsafe signal S for fixing the number of revolutions of the engine to the minimum other than a maneuver signal. The controlled object side communication device 30 amplifies and demodulates a signal received in a high frequency circuit 31. Then, the signal is sorted and outputted to a drive control portion 33 such as servo device by a decoder 32. At this time, a maneuver signal M of the servo device for controlling the engine is outputted to a switching circuit 34 together with a battery failsafe signal S.

The switching circuit 34 normally outputs the maneuver signal M. When the power source voltage detected by a voltage detection circuit 35 becomes under a reference voltage value, the switching circuit 34 outputs the battery failsafe signal S to the servo device instead of the maneuver signal M. Before the operation of the controlled object is disabled, while the controlled object is controlled by the battery failsafe signal S, the controlled object can be stopped in a safe place and collected.

Further, a radio control receiver described in PTL 2 includes a memory for storing a reference voltage value which is changed corresponding to a type of battery because a proper reference voltage value to activate the battery failsafe function is varied corresponding to the type of battery.

Further, in a recent radio control system for hobby use, a radio control technique of two-way communication is used in which a detection value of an engine rotation sensor mounted on the controlled object or a sensor of a power source voltage detection portion is transmitted from the controlled object side communication device, and displayed on a display portion mounted on the maneuvering gear.

### CITATION LIST

### Patent Literature

[PTL 1] JP, A, S61-239796
[PTL 2] JP, A, 2011-78707

### SUMMARY OF INVENTION

### Technical Problem

In the two-way communication radio control system, the controlled object side communication device not only receives a radio wave from the maneuvering gear, but also transmits. Therefore, the power source battery consumption is larger than the controlled object side communication device of the conventional one-way communication radio control system. In particular, the battery consumption of transmitting is larger than receiving. Therefore, there is a problem that in the two-way communication radio control system, available time for remotely controlling the controlled object is short compared to the one-away communication radio control system.

In particular, when the two-way radio control system is operated with a reference voltage value of the power source where the conventional battery failsafe function works, there is a fear that the power source voltage may be reduced and the operation may be disabled before the controlled object is stopped in a safe place and collected. Further, when the reference voltage value is set higher than the conventional system, there is a problem that the battery failsafe function works in a section where the normal use is available. In such a case, when the power source battery is a secondary battery, a battery life may become short by an increase of charge-discharge cycle without using the battery sufficiently.

Accordingly, in view of the above problems, an object of the present invention is to provide a wireless communication system configured to reduce power consumption of the controlled object side communication device, and extend available time of the radio control system, in particular, the wireless communication system configured to reduce power consumption of the controlled object side communication device for stopping and collecting the controlled object after the battery failsafe function works.

### Solution to Problem

According to a first aspect of the present invention, there is provided a controlled object side communication device used in a wireless communication system in which a maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,

said controlled object side communication device including:
a voltage detection portion for detecting a power source voltage;
a data signal generation portion for generating a data signal including power source voltage data detected by the voltage detection portion; and a controlled object side control portion for controlling a transmission interval of the data signal according to the power source voltage data.

According to a second aspect of the present invention, there is provided a controlled object side communication device used in a wireless communication system in which a maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,

said controlled object side communication device including:
a voltage detection portion for detecting a power source voltage;
a data signal generation portion for generating a data signal including power source voltage data detected by the voltage detection portion;
a controlled object side transceiving portion for receiving a data request signal from the maneuvering gear;
a voltage comparison portion for comparing the power source voltage data with a reference voltage value; and
a failsafe function portion for outputting a failsafe signal which controls the controlled object in a specific way and adding failsafe data to the data signal when the power source voltage data is equal to or lower than the reference voltage value.

According to a third aspect of the present invention, there is provided a maneuvering gear used in a wireless communication system in which the maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,

said maneuvering gear including:
a maneuver side transceiving portion for transmitting a data request signal to the controlled object side communication device; and
a data request interval control portion for controlling a transmitting interval of the data request signal corresponding to power source voltage data included in the received data signal.

According to a fourth aspect of the present invention, there is provided the maneuvering gear as described in the third aspect,

wherein the data request interval control portion controls so as to lengthen the transmitting interval of the data request signal when detecting failsafe data from the data signal.

According to a fifth aspect of the present invention, there is provided the maneuvering gear as described in the fourth aspect,

wherein the data request interval control portion controls the transmitting interval of the data request signal into a plurality of steps corresponding to the power source voltage data included in the data signal when detecting failsafe data from the data signal.

According to a sixth aspect of the present invention, there is provided the maneuvering gear as described in any one of the third to fifth aspects, further including:

a maneuver side voltage comparison portion for comparing the power source voltage data included in the data signal with a maneuver side reference voltage value; and
an alarm portion for generating an alarm when the power source voltage data is equal to or lower than the maneuver side reference voltage value.

According to a seventh aspect of the present invention, there is provided the maneuvering gear as described in the fourth or fifth aspect, further including:

an alarm portion for generating an alarm when detecting the failsafe data from the data signal.

According to an eighth aspect of the present invention, there is provided a wireless communication system in which a maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object, wherein the controlled object side communication device includes:

a controlled object side transceiving portion for receiving a data request signal from the maneuvering gear, and transmitting the data signal corresponding to the data request signal;
a voltage detection portion for detecting a power source voltage; and
a data signal generation portion for generating a data signal including power source voltage data detected by the voltage detection portion, and wherein the maneuvering gear including:
a maneuver side transceiving portion for transmitting a data request signal to the controlled object side communication device; and
a data request interval control portion for controlling a transmitting interval of the data request signal corresponding to power source voltage data included in the received data signal.

According to a ninth aspect of the present invention, there is provided the wireless communication system as described in the eighth aspect, wherein the controlled object side communication device including:

a voltage comparison portion for comparing the power source voltage data with a reference voltage value; and
a failsafe function portion for outputting a failsafe signal which controls the controlled object in a specific way and adding failsafe data to the data signal when the power source voltage data is equal to or lower than the reference voltage value, and
wherein the data request interval control portion of the maneuvering gear controls so as to lengthen the transmitting interval of the data request signal when detecting failsafe data from the data signal.

According to a tenth aspect of the present invention, there is provided the wireless communication system as described in the ninth aspect, wherein the data request interval control portion of the maneuvering gear controls the transmitting interval of the data request signal into a plurality of steps corresponding to the power source voltage data included in the data signal when detecting failsafe data from the data signal.

### Advantageous Effects of Invention

Because the present invention has the above configuration, the power consumption of the controlled object side communication device is reduced, and available time of the radio control system can be extended. Further, by lengthening the transmitting interval of the data request signal after the battery failsafe function works, the power source voltage can be maintained. Thereby, the time until the controlled object is stopped in a safe place can be secured enough.

Further, because the alarm portion installed in the maneuvering gear works, an operator can intuitively confirm that the controlled object side power source voltage is reduced.

These and other objects, features, and advantages of the present invention will become more apparent upon reading of the following detailed description along with the accompanied drawings.

### BRIEF DESCRIPTION OF DRAWINGS

FIG. 1 is a block diagram showing a configuration example of a wireless communication system;

FIG. 2 is a flowchart showing a processing flow of the wireless communication system upon data request;

FIGS. 3A to 3C are a timing chart showing an example of communication behavior of the wireless communication system;

FIG. 4 is a block diagram showing a configuration example of another embodiment of a maneuvering gear; and

FIG. 5 is a block diagram showing a configuration example of a conventional controlled object side communication device.

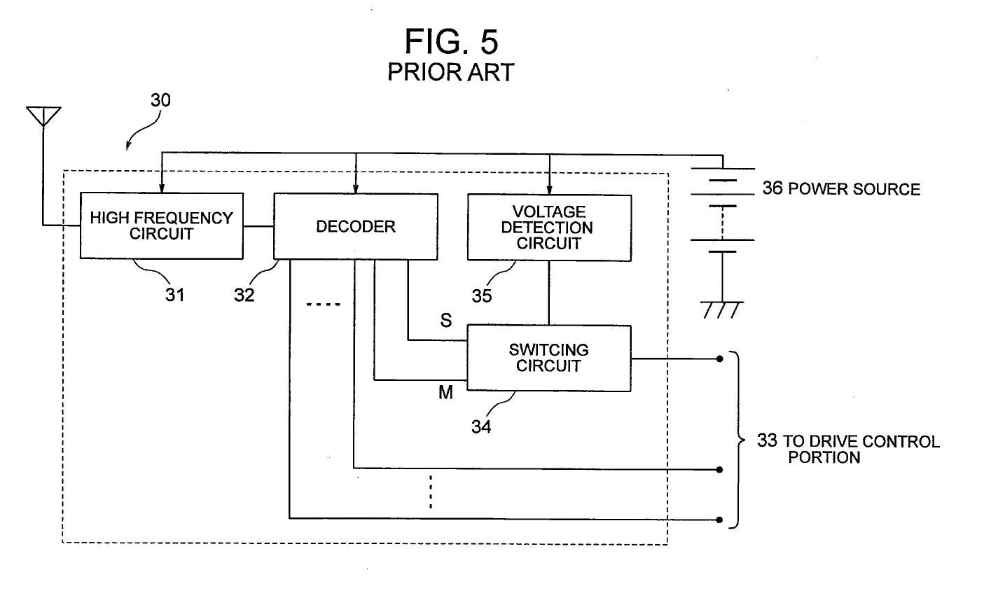

### DESCRIPTION OF EMBODIMENTS

### First Embodiment

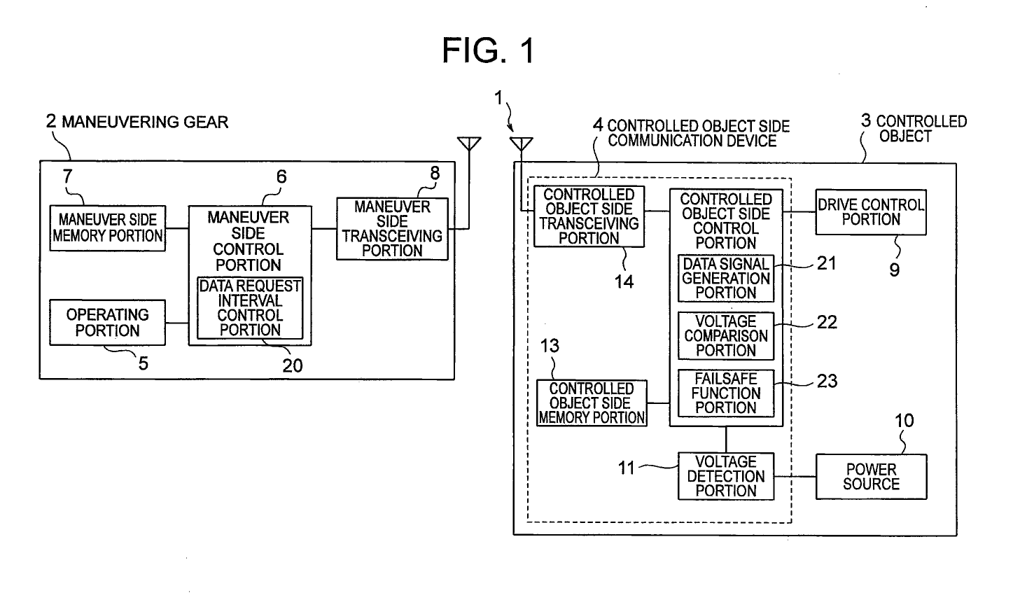

A first embodiment will be explained with reference to attached FIGS. 1 to 3. FIG. 1 is a block diagram showing a configuration example of a wireless communication system 1 according to the present invention. A maneuvering gear 2 is a device for maneuvering a controlled object 3. An operator operates an operating portion 5 to drive and control the controlled object 3 and to change a setting of the maneuvering gear 2. The operating portion 5 includes: a switch, a stick, a lever, a touch panel and the like.

A maneuver side control portion 6 changes the setting of the maneuvering gear 2 corresponding to an operation of the operating portion 5, and generates a maneuver signal for driving and controlling the controlled object 3. The maneuver side control portion 6 includes a CPU (Central Processing Unit) which actually handles tasks. Further, the maneuver side control portion 6 further includes a data request interval control portion 20 configured to control a data request interval for detecting conditions of a controlled object side communication device 4 and the controlled object 3.

A maneuver side memory portion 7 is a memory for storing various settings of the maneuvering gear 2. A maneuver side transceiving portion 8 transmits a maneuver signal and a data request signal for detecting conditions of the controlled object side communication device 4 and the controlled object 3, and receives a data signal transmitted by the controlled object side communication device 4.

The data request signal instructs the controlled object side communication device 4 to transmit data when the maneuvering gear 2 acquires the conditions of the controlled object side communication device 4 and the controlled object 3. Further, the data signal is composed of a detected value of sensors provided on the controlled object side communication device 4 and the controlled object 3. In this embodiment, the data signal includes power source voltage data detected by a voltage detection portion 11. In addition, when sensors such as a rotation sensor of a not-shown engine or a temperature sensor are provided, detected value of them can be included in the data signal. Further, the data signal also includes failsafe data indicating that a failsafe function works in the controlled object side communication device 4.

The controlled object side communication device 4 is mounted on the controlled object 3, receives the maneuver signal transmitted by the maneuvering gear 2, and outputs the maneuver signal to a drive control portion 9. In FIG. 1, only one drive control portion 9 is shown. However, a plurality of drive control portions 9 may be connected properly as necessary such as a servo device for driving and controlling a throttle lever of the engine or the like, and a gyro device for maintaining stability in a horizontal direction of the controlled object 3 such as a model helicopter.

A battery such as NiCad battery, nickel-hydrogen battery, and lithium polymer battery is used as a power source 10, and mounted on the controlled object 3. Generally, the power source 10 is shared between the controlled object side communication device 4 and the drive control portion 9. The voltage detection portion 11 detects the voltage of the power source 10, and outputs to a controlled object side control portion 12 as the power source voltage data.

The controlled object side control portion 12 decodes the maneuver signal and outputs to the drive control portion 9. Further, the controlled object side control portion 12 includes a data signal generation portion 21 for generating a data signal in response to the data request signal of the maneuvering gear 2.

The controlled object side control portion 12 also includes: a voltage comparison portion 22 for comparing the power source voltage data with a reference voltage value stored in a controlled object side memory portion 13; and a failsafe function portion 23 for outputting a failsafe signal to the drive control portion 9 and adding the failsafe data to the data signal when the power source voltage data is equal to or lower than the reference voltage value. The controlled object side control portion 12 handles the actual processing with CPU.

The failsafe signal is a signal for previously fixing an active position of the servo device in the drive control portion 9 to a specific position in order to realize a battery failsafe function. When the controlled object 3 is a model airplane, and the failsafe signal controls the servo device for controlling each steering drive, the steering is fixed to a specific position to rotate the controlled object 3 or the like. Further, when the failsafe signal controls the servo device for controlling a throttle lever of an engine, an engine speed is controlled to the minimum or the like.

The controlled object side memory portion 13 stores the reference voltage value used by the voltage comparison portion 22 in the controlled object side control portion 12, and various settings of the controlled object side communication device 4. A controlled object side transceiving portion 14 performs a receiving process for receiving the maneuver signal and the data request signal and outputting to the controlled object side control portion 12, and performs a transmitting process for transmitting the data signal to the maneuvering gear 2.

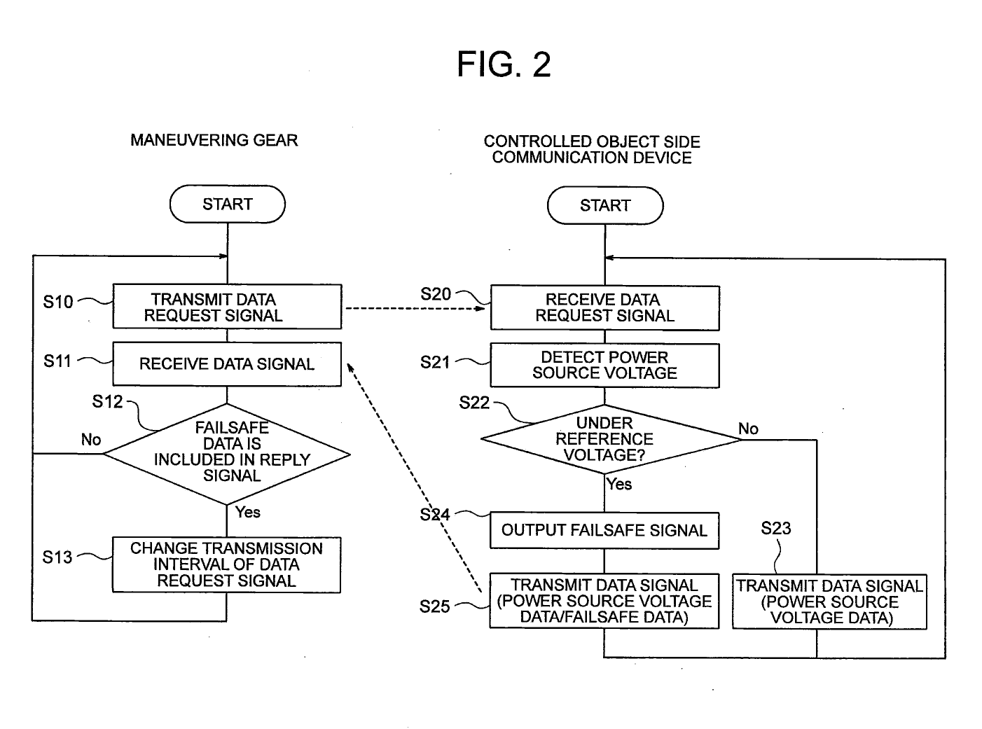

FIG. 2 is a flowchart showing a process flow when a data request is sent from the maneuvering gear 2 to the controlled object side communication device 4. FIG. 2 shows a communication behavior after the maneuvering gear 2 and the controlled object side communication device 4 are synchronized with each other. The process flow will be explained with reference to FIGS. 1 and 2.

First, in step S10 of FIG. 2, the maneuvering gear 2 transmits the data request signal. In step S20, the controlled object side communication device 4 receives the data request signal. When the controlled object side communication device 4 receives the data request signal, the voltage detection portion 11 measures the voltage of the power source 10. The detected power source voltage is compared with the reference voltage value by the voltage comparison portion 22 in the controlled object side control portion 12.

When the power source voltage data is larger than the reference voltage value (“No” in step 22), the data signal generation portion 21 generates the data signal including the power source voltage data and transmits to the maneuvering gear 2 in step S23. Then, the controlled object side communication device 4 returns to a condition of waiting to receive the data request signal of the maneuvering gear 2.

When the power source voltage is equal to or lower than the reference voltage value (“Yes” in step 22), the failsafe function portion 23 activates the failsafe function and outputs the failsafe signal to the drive control portion 9 in step S24. Then, in step S25, the data signal generation portion 21 generates the data signal including the power source voltage data, adds the failsafe data indicating that the failsafe function works to the data signal, and transmits to the maneuvering gear 2. Then, the controlled object side communication device 4 returns to a condition of waiting to receive the data request signal of the maneuvering gear 2.

In step S11, the maneuvering gear 2 receives the data signal. The data signal includes the power source voltage data and the like showing conditions of the controlled object side communication device 4 and the controlled object 3. Then, in step S12, the maneuver side control portion 6 discriminates whether the data signal includes the failsafe data or not. When the failsafe data is not included (“No” in step S12), the maneuvering gear 2 returns to a condition of transmitting the data request signal at conventional intervals.

Further, when the failsafe data is included (“Yes” in step S12), the data request interval control portion 20 changes an interval of transmitting the data request signal in step S13. Then, the maneuvering gear 2 returns to a condition of transmitting the data request signal. At this time, the interval of transmitting the data request signal after confirming that the failsafe data is included is changed longer than that of the normal condition.

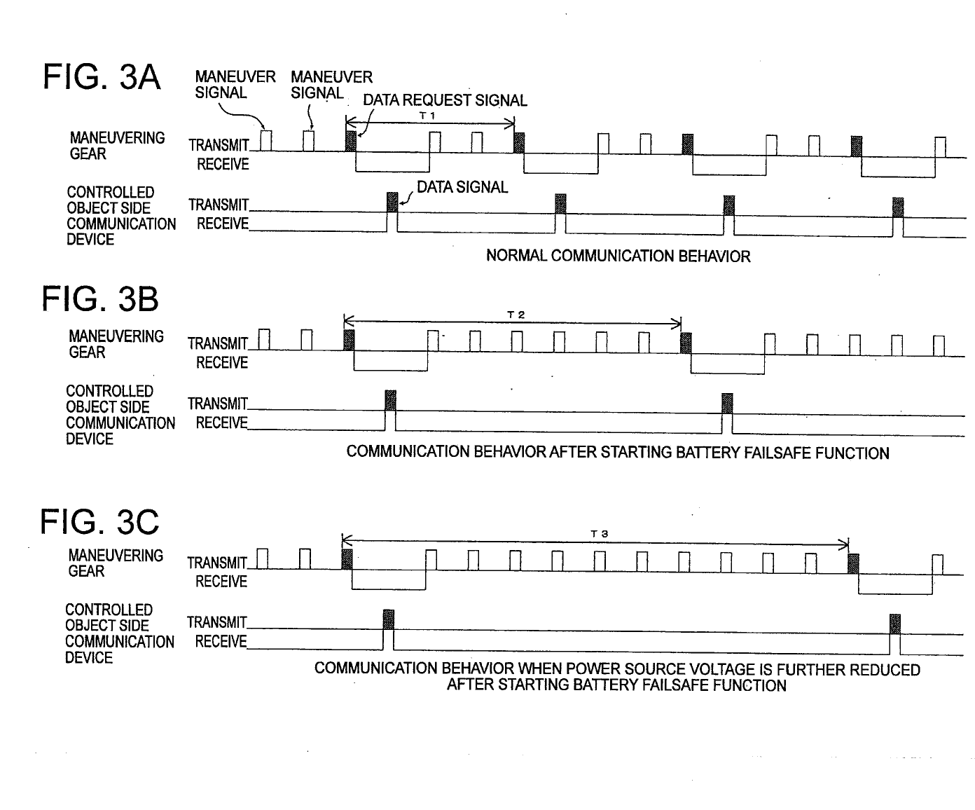

FIGS. 3A to 3C are a schematic view showing a communication behavior between the maneuvering gear 2 and the controlled object side communication device 4 as the wireless communication system 1. FIGS. 3A to 3C show the communication behavior after the maneuvering gear 2 and the controlled object side communication device 4 are synchronized with each other. A transceiving behavior will be explained with reference to FIGS. 1 and 3A to 3C.

First, FIG. 3A shows an example of a normal communication behavior. The maneuvering gear 2 normally transmits the maneuver signal at specific intervals, and transmits the maneuver signal and the data request signal at the same time at an interval T1. After transmitting the data request signal, the maneuvering gear 2 is in a receiving condition in a specific time period. The controlled object side communication device 4 normally wait to receive, and when the maneuver signal is received, handles a process. Further, when the data request signal is received, the controlled object side communication device 4 transmits the data signal to the maneuvering gear 2 according to a flowchart process shown in FIG. 2. After this, this behavior is repeated at a specific interval T1.

When the power source voltage of the controlled object side communication device 4 is equal to or lower than the reference voltage value, and the failsafe function works, the failsafe data is added to the data signal and transmitted to the maneuvering gear 2. The data request interval control portion 20 of the maneuvering gear 2 changes a transmission interval of the data request signal, and a transceiving behavior is as shown in FIG. 3B. At this time, an interval of transmitting the maneuver signal and the data request signal at the same time by the maneuvering gear 2 becomes T2 which is longer than T1 of the normal case. In FIG. 3, T2 is twice as long as T1.

Owing to this process, an interval of transmitting the data signal by the controlled object side communication device 4 also becomes T2 from T1. Because the interval of a transmission process of the controlled object side communication device 4 becomes longer, power consumption of the power source 10 is reduced, and the controlled object 3 can be stopped in a safe place and collected after the failsafe function starts working.

### Second Embodiment

A second embodiment of the present invention will be explained with reference to FIG. 3. The configuration of the wireless communication system 1 of the second embodiment is the same as the first embodiment. The data request interval control portion 20 in the maneuver side control portion 6 can change the data request interval in a plurality of steps corresponding to the power source voltage data in the data signal.

A transceiving behavior will be explained with reference to FIGS. 3A to 3C. Similar to the first embodiment, the normal transceiving behavior is as FIG. 3A. Then, when the failsafe data is included in the data signal, the data request interval control portion 20 changes the transmission interval of the data request signal, and the transceiving behavior is changed as FIG. 3B.

According to the second embodiment, when the power source voltage is further reduced after the failsafe function works in the controlled object side communication device 4, the maneuvering gear 2 receives the data signal including the power source voltage data, and the data request interval control portion 20 confirms that the power source voltage is lower than a specific voltage value, and then the transmission interval becomes T3 which is longer than T2 as shown in FIG. 3C. In FIG. 3C, T3 is three times as large as T1.

In FIGS. 3A to 3C, the transmission interval of the data request signal is changed in two steps. However, by changing the setting of the data request interval control portion 20, the transmission interval of the data request signal can be changed more than two steps corresponding to the power source voltage data. Further, the lengths of the T1, T2, and T3 can be set freely as long as T1<T2<T3.

### Third Embodiment

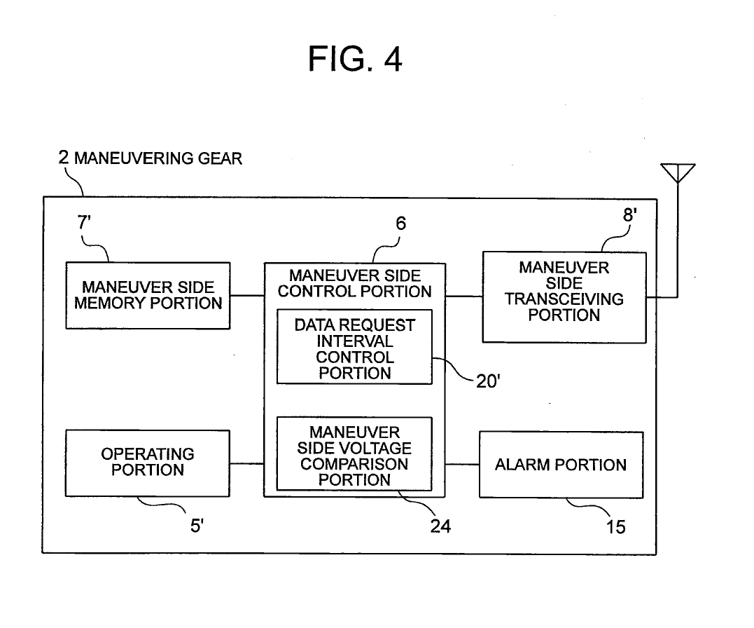

A configuration example of a maneuvering gear 2′ of the wireless communication system 1 according to a third embodiment will be explained with reference to FIG. 4.

The maneuvering gear 2′ includes an alarm portion 15. The alarm portion 15 notifies an operator of a reduction of the power source voltage of a not-shown controlled object, or of an accident. The alarm portion 15 optionally includes: a display for displaying various information; a luminescent device such as a small LED; a warning device for generating a warning sound; and the like.

Further, a maneuver side memory portion 7′ stores a maneuver side reference voltage value for comparing with the power source voltage data in the data signal transmitted from a not-shown controlled object side communication device. Further, a maneuver side control portion 6′ includes a maneuver side voltage comparison portion 24 for comparing the power source voltage data with the maneuver side reference voltage value.

Next, a unique process of the third embodiment will be explained. When the failsafe data is included in the data signal received from the not-shown controlled object side communication device, the data request interval control portion 20 changes the transmission interval of the data request signal similar to the first embodiment. At this time, the transmission interval of the data request signal after confirming that the failsafe data is included is longer than the normal condition. Then, the alarm portion 15 notifies the operator that the battery failsafe function works in the controlled object side communication device.

Further, it is also possible that a specific maneuver side reference voltage value is previously set in the maneuver side memory portion 7′, the maneuver side voltage comparison portion 24 compares the power source voltage data in the data signal with the maneuver side reference voltage value, and when the power source voltage data is equal to or lower than the maneuver side reference voltage value, the alarm portion 15 sends an alarm to the operator.

The maneuver side reference voltage value in the maneuver side memory portion 7′ can be freely changed by the operating portion 5′. A value other than the reference voltage value upon which the battery failsafe function works in the controlled object side control portion 12 can be set. With this, when the maneuver side reference voltage value is set a little higher than the reference voltage value upon which the battery failsafe function works, the alarm is sent to the operator before the failsafe function works, thereby the controlled object can be stopped more safely.

Incidentally, according to the first to third embodiment, when the controlled object side communication device receives the data request signal, the controlled object side communication device generates and transmits the data signal. However, even when the maneuvering gear do not transmits the data request signal, it is possible that the controlled object side communication device transmits the data signal in a specific period. In this case, the controlled object side control portion changes the transmission interval corresponding to the power source voltage data, thereby the same effect as the first to third embodiment is attained.

Further, according to the first to third embodiment, after the failsafe data included in the data signal is detected, the transmission interval of the data request signal is controlled. However, it is possible that the transmission interval of the data request signal is controlled based on the power source voltage data of the data signal received by the maneuvering gear. In this case, the data request interval control portion of the maneuvering gear changes the transmission interval of the data request signal, thereby the same effect as the first to third embodiment is attained.

Incidentally, the present invention is not limited to the first to third embodiment. It is to be understood that various changes and modifications will be apparent to those skilled in the art. Therefore, unless otherwise such changes and modifications depart from the scope of the present invention hereinafter defined, they should be construed as being included therein.

What is claimed is:

1. A controlled object side communication device used in a wireless communication system in which a maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,
said controlled object side communication device comprising:
a voltage detection portion for detecting a power source voltage;
a data signal generation portion for generating a data signal including power source voltage data detected by the voltage detection portion; and
a controlled object side control portion for controlling a transmission interval of the data signal according to the power source voltage data.

2. A controlled object side communication device used in a wireless communication system in which a maneuvering gear transmits a radio wave of a maneuver signal, the controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,
said controlled object side communication device comprising:
a voltage detection portion for detecting a power source voltage;
a data signal generation portion for generating a data signal including power source voltage data detected by the voltage detection portion;
a controlled object side transceiving portion for receiving a data request signal from the maneuvering gear;
a voltage comparison portion for comparing the power source voltage data with a reference voltage value; and
a failsafe function portion for outputting a failsafe signal which controls the controlled object in a specific way and adding failsafe data to the data signal when the power source voltage data is equal to or lower than the reference voltage value.

3. A maneuvering gear used in a wireless communication system in which the maneuvering gear transmits a radio wave of a maneuver signal, a controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,
said maneuvering gear comprising:
a maneuver side transceiving portion for transmitting a data request signal to the controlled object side communication device; and
a data request interval control portion for controlling a transmitting interval of the data request signal corresponding to power source voltage data included in the received data signal.

4. The maneuvering gear as claimed in claim 3,
wherein the data request interval control portion controls so as to lengthen the transmitting interval of the data request signal when detecting failsafe data from the data signal.

5. The maneuvering gear as claimed in claim 4,
wherein the data request interval control portion controls the transmitting interval of the data request signal into a plurality of steps corresponding to the power source voltage data included in the data signal when detecting failsafe data from the data signal.

6. The maneuvering gear as claimed in claim 3, further comprising:
a maneuver side voltage comparison portion for comparing the power source voltage data included in the data signal with a maneuver side reference voltage value; and
an alarm portion for generating an alarm when the power source voltage data is equal to or lower than the maneuver side reference voltage value.

7. The maneuvering gear as claimed in claim 4, further comprising:
a maneuver side voltage comparison portion for comparing the power source voltage data included in the data signal with a maneuver side reference voltage value; and
an alarm portion for generating an alarm when the power source voltage data is equal to or lower than the maneuver side reference voltage value.

8. The maneuvering gear as claimed in claim 5, further comprising:
a maneuver side voltage comparison portion for comparing the power source voltage data included in the data signal with a maneuver side reference voltage value; and
an alarm portion for generating an alarm when the power source voltage data is equal to or lower than the maneuver side reference voltage value.

9. The maneuvering gear as claimed in claim 4, further comprising:
an alarm portion for generating an alarm when detecting the failsafe data from the data signal.

10. The maneuvering gear as claimed in claim 5, further comprising:
an alarm portion for generating an alarm when detecting the failsafe data from the data signal.

11. A wireless communication system in which a maneuvering gear transmits a radio wave of a maneuver signal, a controlled object side communication device mounted on a controlled object receives the signal to control a drive control portion of the controlled object, the controlled object side communication device transmits a radio wave of a data signal indicating a condition of the controlled object, and the maneuvering gear receives the data signal to monitor the condition of the controlled object,
wherein the controlled object side communication device includes:
a controlled object side transceiving portion for receiving a data request signal from the maneuvering gear, and transmitting the data signal corresponding to the data request signal;
a voltage detection portion for detecting a power source voltage; and
a data signal generation portion for generating a data signal including power source voltage data detected by the voltage detection portion, and
wherein the maneuvering gear including:
a maneuver side transceiving portion for transmitting a data request signal to the controlled object side communication device; and
a data request interval control portion for controlling a transmitting interval of the data request signal corresponding to power source voltage data included in the received data signal.

12. The wireless communication system as claimed in claim 11,
wherein the controlled object side communication device including:
a voltage comparison portion for comparing the power source voltage data with a reference voltage value; and
a failsafe function portion for outputting a failsafe signal which controls the controlled object in a specific way and adding failsafe data to the data signal when the power source voltage data is equal to or lower than the reference voltage value, and
wherein the data request interval control portion of the maneuvering gear controls so as to lengthen the transmitting interval of the data request signal when detecting failsafe data from the data signal.

13. The wireless communication system as claimed in claim 12,
wherein the data request interval control portion of the maneuvering gear controls the transmitting interval of the data request signal into a plurality of steps corresponding to the power source voltage data included in the data signal when detecting failsafe data from the data signal.
